(19) United States
(12) Patent Application Publication
(10) Pub. No.: US 2023/0101473 A1
(43) Pub. Date: Mar. 30, 2023

(54) DIGITAL CONTENT SECONDARY DISTRIBUTION SYSTEM

(71) Applicant: Nomura Research Institute, Ltd., Tokyo (JP)

(72) Inventor: Tetsuya Makino, Yokohama (JP)

(21) Appl. No.: 17/940,378

(22) Filed: Sep. 8, 2022

(30) Foreign Application Priority Data
Sep. 29, 2021 (JP) 2021-158626

(51) Int. Cl. G06Q 20/12; G06Q 30/06

(52) U.S. Cl. CPC G06Q 20/123; G06Q 30/0641

(57) ABSTRACT

A digital content secondary distribution system that supports secondary distribution of digital content includes: a secondary distribution license processing unit that receives and records, into a secondary distribution book DB, designation of first digital content for which secondary distribution by an issuer is licensed; a putting up management unit that receives and records, into a putting up DB, an instruction to put up second digital content by a first user who purchased and possessed the first digital content; and a purchase processing unit that receives an instruction to purchase the second digital content by a second user and updates information in the putting up DB, in which the putting up management unit limits the number of times identical second digital content can be put up to equal to or less than a predetermined number of times.

### BACKGROUND OF THE INVENTION

### 1. Technical Field

The present invention relates to a technology for supporting and managing distribution of digital content, and more particularly to a technology effective for application to a digital content secondary distribution system for supporting and managing secondary distribution of digital content.

### 2. Description of the Related Art

Paper-based content such as books has always had a sufficient-size market of secondary distribution of secondhand products, in addition to a market of primary distribution of new publications. On the other hand, as for digital content such as electronic books, while the market of primary distribution has grown in recent years, and further has rapidly grown in combination with stay-at-home demand due to the COVID-19 disaster, secondary distribution is carried out partially but the market size is small, and there is no dominant player actually.

As a technology related to secondary distribution of digital content, for example, Japanese Patent No. 6087469 describes an electronic content distribution system including an electronic content management server device, a resale management server device, a plurality of sales server devices each providing a sales site of electronic content, and a plurality of user terminal devices, and the resale management server device has a price setting means for performing determination of a first coefficient based on a market distribution amount and a resale inventory amount of the electronic content, and calculation of a purchase price and a resale price using the first coefficient.

### SUMMARY OF THE INVENTION

According to the conventional technology, it is possible to achieve a market of secondary distribution of digital content such as electronic books.

On the other hand, in order to widely spread the market of secondary distribution of digital content, there is a demand for a mechanism that can achieve the secondary distribution market without requiring a major change or modification in a relationship and a system between existing publishers, authors, writers (hereinafter, these are sometimes collectively referred to simply as “publishers”) and electronic bookstores, and that is profitable for the publishers, the electronic bookstores, and the users in terms of revenue, convenience, and the like. It is an object of the invention of the present application to solve such a mechanism by a technical system, and to provide a platform as a base without customization development of a system of each company. More specifically, in a case where there are M systems on the publisher side and N systems on the electronic book side, M×N individual system development is required, and technical difficulties in system development on a case-by-case basis vary.

Therefore, an object of the present invention is to provide a digital content secondary distribution system capable of achieving the above-described mechanism. The above and other objects and novel features of the present invention will become apparent from the description of the present description and the accompanying drawings.

The outline of a representative invention of the inventions disclosed in the present application will be briefly described as follows.

A digital content secondary distribution system according to a representative embodiment of the present invention is a digital content secondary distribution system that supports secondary distribution, by a user, of digital content purchased and possessed by the user, the digital content secondary distribution system including: a secondary distribution license processing unit that receives and records, into a secondary distribution book recording unit, designation, by an issuer of the digital content, of first digital content for which secondary distribution is licensed among digital content issued by the issuer; a putting up management unit that receives and records, into a putting up recording unit, an instruction, by a first user who purchases and possesses the first digital content from a seller, of putting up via the seller, of second digital content of the first digital content that is possessed; and a purchase processing unit that receives an instruction, by a second user, of purchase of the second digital content sold by the first user, and updates information on the putting up recording unit, in which the putting up management unit limits a number of times the second digital content that is identical can be put up to equal to or less than a predetermined number of times.

The advantageous effect of the representative one of the inventions disclosed in the present application will be briefly described as follows.

That is, according to the representative embodiment of the present invention, it is possible to achieve the secondary distribution market of digital content without requiring a major change or modification in a relationship and a system between existing publishers and electronic bookstores, and that is profitable for the publishers, the electronic bookstores, and the users in terms of revenue, convenience, and the like.

### BRIEF DESCRIPTION OF THE DRAWINGS

FIG. 1 is a view illustrating an outline of a configuration example of a digital content secondary distribution system that is one embodiment of the present invention;

FIG. 2 is a view illustrating an outline of an example of an overall processing flow in one embodiment of the present invention;

FIG. 3 is a view illustrating an outline of an example of a license processing flow of secondary distribution by a publisher in one embodiment of the present invention;

FIG. 4 is a view illustrating an outline of an example of a flow of putting up processing of an electronic book in a secondary distribution market by a user in one embodiment of the present invention;

FIG. 5 is a view illustrating an outline of an example of a flow of purchase processing of an electronic book from a secondary distribution market by a user in one embodiment of the present invention;

FIG. 6 is a view illustrating an outline of an example of a screen displayed on a user terminal by an electronic book selling system in one embodiment of the present invention; and

FIG. 7 is a view illustrating an outline of an example of a screen displayed on a user terminal by an electronic book selling system in one embodiment of the present invention.

### DETAILED DESCRIPTION

An embodiment of the present invention will be described in detail below with reference to the drawings. In all the drawings for describing the embodiment, identical parts are in principle given identical reference signs, and duplicated descriptions thereof will be omitted. Meanwhile, a part described with a reference sign in a figure may be referred to with the same reference sign in the description of another figure although not illustrated again.

### Outline

A digital content secondary distribution system that is one embodiment of the present invention is an information processing system that provides an electronic bookstore with, as an application programming interface (API), a function that enables putting up (secondarily selling) digital content such as an electronic book that a user purchased (that is, has access to book) and purchasing secondarily distributed digital content, thereby achieving and supporting secondary selling of digital content by the user.

This enables the electronic bookstore to easily achieve the secondary distribution market of digital content, enables the user to have an opportunity to easily and inexpensively purchase digital content, and enables the secondary distribution market of digital content to be activated. It is possible to also activate the primary distribution market by, for example, returning a point as compensation to a user who has put up an item on the secondary distribution market when the item is purchased and making the point usable for purchase of digital content in the primary distribution market. It is possible to support creation of digital content to be newly sold in the primary distribution market and lead to activation of the primary distribution market by returning a part of sales of secondary distribution to the publisher as a license fee, for example.

In the present embodiment, an electronic book published and issued by a publisher will be described as digital content to be distributed primarily/secondarily, but the type of digital content is not particularly limited. As long as viewing and use are controlled by access to book or a right to use, and content is distributed in a form in which the access to book or the right to use is granted by purchasing the content, it is possible to target, for example, video content such as a moving image, music content, and the like. The entity (seller) that sells these pieces of content is not limited to an electronic bookstore but may be a sales site and the like, and the entity (issuer) that issues these pieces of content is not limited to a publisher but may be another company, an individual, and the like.

### System Configuration

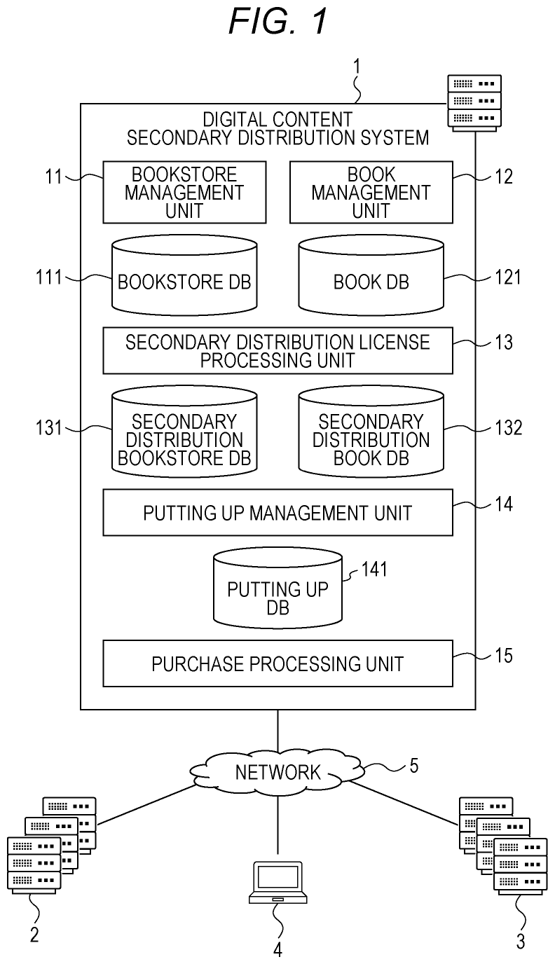

FIG. 1 is a view illustrating an outline of a configuration example of a digital content secondary distribution system that is one embodiment of the present invention. A digital content secondary distribution system 1 includes, for example, a virtual server built on a server device, a cloud computing service, or the like, and achieves various functions related to secondary distribution of digital content as described later by a central processing unit (CPU) not illustrated executing an operating system (OS) expanded on a memory from a recording device such as a hard disk drive (HDD), middleware such as a database management system (DBMS) and a web server program, or software operating thereon.

A publisher management system 2 is an information processing system or a website that manages information on an electronic book published and issued by each publisher. An electronic book selling system 3 is an information processing system or a website in which each electronic bookstore runs business of selling electronic books. Using a user terminal 4 including a personal computer (PC) and a portable terminal such as a smartphone and a tablet terminal, the user of the electronic book can access the electronic book selling system 3 via a network 5 such as the Internet, purchase electronic books distributed primarily/secondarily, and put up (secondarily sell) electronic books.

The publisher management systems 2 of a plurality of publishers and the electronic book selling systems 3 of a plurality of electronic bookstores can access the digital content secondary distribution system 1 via the network 5 and use various functions related to secondary distribution of electronic books. In the present embodiment, as described above, the digital content secondary distribution system 1 provides various functions as an API, and each publisher management system 2 and each electronic book selling system 3 use various functions related to secondary distribution of electronic books by calling these APIs ad hoc.

That is, the digital content secondary distribution system 1 that is independent can add a secondary distribution function, without major modification, to a mechanism of primary distribution of electronic books that has been conventionally carried out by the publisher management system 2 and the electronic book selling system 3. A front-end portion such as an interface for the user (user terminal 4) is handled by an electronic bookstore implemented by the electronic book selling system 3 as ever. Not limited to such a system configuration, it is possible to incorporate, as an API, into a content management system (CMS) used for implementation of the electronic book selling system 3, for example, or it is possible to integrally incorporate into the electronic book selling system 3.

The digital content secondary distribution system 1 has each unit such as a bookstore management unit 11, a book management unit 12, a secondary distribution license processing unit 13, a putting up management unit 14, and a purchase processing unit 15 implemented as software, for example. The digital content secondary distribution system 1 has each data store such as a bookstore database (DB) 111, a book DB 121, a secondary distribution bookstore DB 131, a secondary distribution book DB 132, and a putting up DB 141 implemented as a database or a file table.

The bookstore management unit 11 has a function of managing information related to an electronic bookstore that carries out primary distribution and secondary distribution recorded in the bookstore DB 111. Master information on each electronic bookstore is recorded in the bookstore DB 111. The book management unit 12 has a function of managing information related to an electronic book to be primarily distributed and secondarily distributed recorded in the book DB 121. Master information on each electronic book is recorded in the book DB 121.

The secondary distribution license processing unit 13 has a function of performing processing related to license of secondary distribution for the electronic book by the publisher. The publisher can designate conditions and restrictions on the electronic book published and issued by the publisher for which secondary distribution is licensed, and the price, period, and the like at the time of secondary distribution. Information on the electronic book for which secondary distribution is licensed and its conditions is recorded in the secondary distribution book DB 132. The publisher can designate an electronic bookstore that handles the electronic book for which secondary distribution is licensed. Information on the designated electronic bookstore is recorded in the secondary distribution bookstore DB 131.

The putting up management unit 14 has a function of managing information related to selling (secondary selling) of the electronic book by the user. The purchase processing unit 15 has a function of managing information regarding purchase by the user related to the electronic book being put up and secondarily distributed. Information related to putting up and purchase of the electronic book is recorded in the putting up DB 141.

### Flow of Processing (Overall)

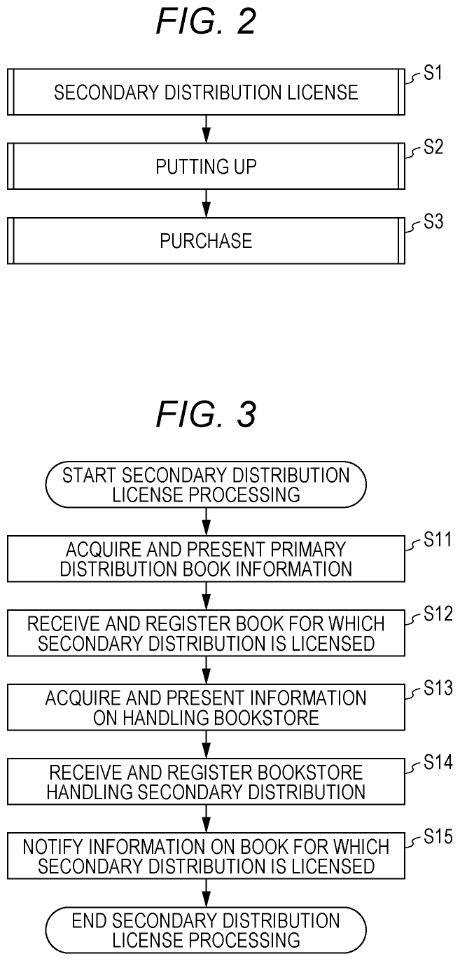

FIG. 2 is a view illustrating an outline of an example of the overall processing flow in one embodiment of the present invention. First, each publisher accesses its own publisher management system 2 and gives license for secondary distribution of the electronic book published and issued by the publisher itself (S1). Then, each user of each electronic bookstore puts up (secondarily sells), via the electronic bookstore (electronic book selling system 3) that the user himself/herself uses, an electronic book for which secondary distribution is licensed among the electronic books that the user himself/herself has already purchased (S2). Then, each user of each electronic bookstore purchases an electronic book that is put up and secondarily distributed via the electronic bookstore (electronic book selling system 3) that the user himself/herself uses (S3).

Hereinafter, the content of each processing of steps S1 to S3 will be described.

### Flow of Processing (Secondary Distribution License (Step S1))

FIG. 3 is a view illustrating an outline of an example of the license processing flow of secondary distribution by a publisher in one embodiment of the present invention. First, the publisher accesses its own publisher management system 2 (or a website provided by this), and, via this, requests the digital content secondary distribution system 1 to acquire information on a primarily distributed electronic book. In the digital content secondary distribution system 1, the book management unit 12 acquires, from the book DB 121, information on an electronic book published by a target publisher, and presents the information to the publisher via the publisher management system 2 (S11).

The publisher designates an electronic book for which secondary distribution is licensed among the presented electronic books, and designates a condition for license. In the digital content secondary distribution system 1, the secondary distribution license processing unit 13 receives information on the electronic book for which secondary distribution is licensed and the condition of the license designated via the publisher management system 2, and registers the information into the secondary distribution book DB 132 (S12). As a method of designating the electronic book for which secondary distribution is licensed, for example, the electronic book may be individually designated in units of titles of the electronic book, or the electronic book meeting the condition such as the unit of the author, the unit of new/old publication, or the like may be comprehensively designated. For a publisher that does not have a system such as the publisher management system 2, a person in charge of operation or the like of the digital content secondary distribution system 1 may receive data from the publisher online or offline and register the data.

Since an electronic book is digital data, it is basically impossible to assume physical deterioration of the product between a primarily distributed new product and a secondarily distributed secondhand product. Therefore, if secondary distribution is permitted to be free, the primary distribution market is negatively affected, for example, the product value of new products is damaged, and as a result, the activation of the secondary distribution market on the premise of the primary distribution market can be inhibited.

Therefore, in the present embodiment, restriction is set in license of secondary distribution by the publisher, and the publisher itself can set restriction. For example, limitation is provided to a starting period at which the publisher can license secondary distribution, and control is performed by the secondary distribution license processing unit 13 or the like such that license of secondary distribution is not possible unless a certain period (for example, one month) elapses after the target electronic book is sold as a new publication in the primary distribution market.

When the publisher licenses secondary distribution, a minimum putting up price is set as a condition for license so as not to allow selling in the secondary distribution market at a price less than the minimum putting up price. These make it possible to maintain the product value of a new product and protect the primary distribution market, and possible to consider not to reduce publishing motivation and creation motivation of the publishers and the authors. The minimum putting up price may be set not only by the publisher but also by the electronic bookstore. Which one to adopt in a case where both are individually set (adopt one with a higher price, give priority to one set by the publisher, and the like) may be appropriately set depending on the requirement.

Thereafter, the publisher management system 2 requests the digital content secondary distribution system 1 to acquire information on an electronic bookstore that handles an electronic book for which secondary distribution is licensed. In the digital content secondary distribution system 1, the bookstore management unit 11 acquires, from the bookstore DB 111, information on an electronic bookstore handling a target electronic book, and presents the information to the publisher via the publisher management system 2 (S13).

The publisher designates an electronic bookstore that is permitted to handle secondary distribution for the target electronic book among the presented electronic bookstores. In the digital content secondary distribution system 1, the secondary distribution license processing unit 13 receives and registers, into the secondary distribution bookstore DB 131, information on the electronic bookstore permitted to handle secondary distribution designated via the publisher management system 2 (S14). The electronic bookstore permitted to handle secondary distribution is similar to the electronic bookstore permitted to handle primary distribution in principle. However, it is possible that secondary distribution is not permitted although primary distribution is permitted in some cases. It is possible to protect the primary distribution market by enabling the publisher side to designate the electronic bookstore permitted to handle secondary distribution in this manner.

Thereafter, the publisher management system 2 notifies, through a screen display or the like, the publisher that the secondary distribution has been licensed for the target electronic book, and requests the digital content secondary distribution system 1 to also notify the electronic bookstore permitted to handle the secondary distribution. In the digital content secondary distribution system 1, the secondary distribution license processing unit 13 notifies the electronic book selling system 3 related to the target electronic bookstore that the secondary distribution has been licensed for the target electronic book (S15), and ends the secondary distribution license processing.

### Flow of Processing (Putting Up (Step S2))

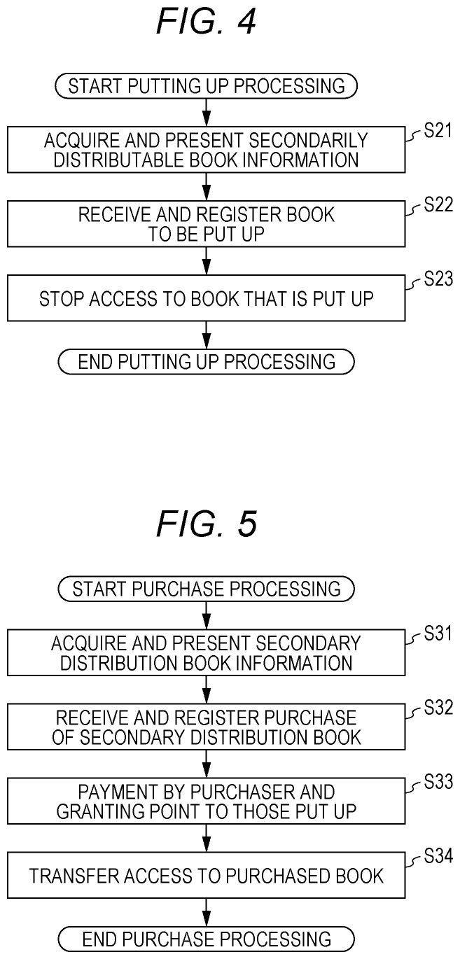

FIG. 4 is a view illustrating an outline of an example of the flow of putting up processing of an electronic book in the secondary distribution market by the user in one embodiment of the present invention. First, the user who intends to put up, in the secondary distribution market, an electronic book purchased by himself/herself accesses the electronic book selling system 3 related to the electronic bookstore from which the user purchased the target electronic book, and, through this, requests the digital content secondary distribution system 1 to acquire information on an electronic book that can be put up in the secondary distribution market (an electronic book for which secondary distribution is licensed by the publisher) among electronic books owned by himself/herself. In the digital content secondary distribution system 1, the putting up management unit 14 acquires the information on the corresponding electronic book from the secondary distribution book DB 132 and presents the information to the user via the electronic book selling system 3 (S21).

The user designates the electronic book to put up in the secondary distribution market among the presented electronic books, and designates its selling price. In the digital content secondary distribution system 1, the putting up management unit 14 receives the information on the target electronic book to be put up and the selling price designated via the electronic book selling system 3, and registers the information into the putting up DB 141 (S22).

The electronic book to be put up in the secondary distribution market does not need to be a new one purchased in a primary distribution market, and a secondhand product purchased in a secondary distribution market may be put up again in the secondary distribution market. Here, as described above, since there is no physical deterioration in the product even if the electronic book is circulated, the primary distribution market can be negatively affected if distribution similar to that of a new product is permitted. Therefore, in the present embodiment, the number of times the identical electronic book can be put up (the number of times of circulation) in the secondary distribution market is limited to, for example, three times, and further putting up is not allowed. That is, the remaining number of times putting up is allowed decreases each time the product is circulated in the secondary distribution market, and this characteristic is given meaning of conceptual deterioration of the product value.

Then, by setting a limit to a discount range that can be set to the selling price in accordance with the number of times of putting up, it is possible to suppress the negative influence on the primary distribution market. For example, in a case of the first putting up where a new product purchased at a regular price from a primary distribution market is put up in a secondary distribution market, the discount range of the selling price that can be set by the user at the time of putting up is limited to up to 30% discount of the purchase price (in this case, the regular price of the new product) of the electronic book. In a case of the second putting up where the user who has purchased this electronic book from the secondary distribution market puts up the electronic book next time, the settable discount range is limited to up to 50% discount of the purchase price of the electronic book. Then, in a case of the third putting up where the user who has purchased the electronic book puts up the electronic book in the secondary distribution market next time, since the user has no right to subsequently put up the electronic book in the secondary distribution market, the discount range can be set up to a maximum of 70% discount of the purchase price of the electronic book.

In any case, it is assumed to be not possible to set a selling price lower than the minimum putting up price set by the publisher or the electronic bookstore in step S12 of FIG. 3 described above. Information on the number of times of putting up (or the remaining number of times putting up is allowed) of each electronic book is recorded in the putting up DB 141 and the secondary distribution book DB 132, for example.

On the other hand, since the circulation of the electronic book is completed only by the exchange of digital data, for example, it is conceivable that transactions only for the purpose of so-called “book scouting” are performed by automatic transaction or the like using a software program for highly demanded books such as paper-based books out-of-print or in short supply, or popular books. Therefore, in the present embodiment, it is not possible to set a price equal to or higher than the purchase price as the selling price at the time of putting up in the secondary distribution market, thereby preventing “book scouting” from being performed.

Judgement as to whether or not to fall under the limitation of the number of times of putting up and the putting up price as described above is performed, for example, by the putting up management unit 14 of the digital content secondary distribution system 1. In a case where putting up is not allowed, the judgement may be notified to the user via the electronic book selling system 3, or the electronic book selling system 3 side may perform control so that putting up exceeding the number of times of putting up or designation of the selling price that conflicts with the limitation of the selling price cannot be performed in the first place.

In the present embodiment, selection of the electronic book to be put up and designation of its selling price are performed by the user. However, for example, activation of the secondary distribution market may be promoted by automatically putting up the electronic book having been read by the user to the secondary distribution market at a predetermined discount rate by setting in advance in the electronic book selling system 3 by the user.

When the information on the electronic book to be put up in the secondary distribution market is registered in the putting up DB 141, the putting up management unit 14 requests the target electronic book selling system 3 to stop the access to book of the user related to the electronic book having been put up (S23). The electronic book selling system 3 ends the putting up processing by performing processing of stopping the access to book of the electronic book and enabling the user to purchase it. Since the access to book is stopped, the user is no longer allowed to browse the target electronic book, but has the ownership.

When the user cancels the putting up of the target electronic book via the electronic book selling system 3, the putting up management unit 14 of the digital content secondary distribution system 1 cancels the putting up of the target (deletes from the putting up DB 141) and requests the electronic book selling system 3 to restore the access to book. In addition to allowing the user to cancel the putting up, the electronic bookstore side may also be allowed to suspend the putting up.

### Flow of Processing (Purchase (Step S3))

FIG. 5 is a view illustrating an outline of an example of the flow of purchase processing of an electronic book from the secondary distribution market by the user in one embodiment of the present invention. First, the user accesses the electronic book selling system 3 related to the electronic bookstore of which the user has an account, and, via this, requests the digital content secondary distribution system 1 to acquire information on the electronic book put up in the secondary distribution market. In the digital content secondary distribution system 1, the putting up management unit 14 acquires information on the electronic book being put up with reference to the putting up DB 141 and presents the information to the user via the electronic book selling system 3 (S31). The electronic book selling system 3 may acquire, from the book DB 121, information on not only those secondarily distributed but also new electronic books primarily distributed, and present the information to the user.

When presenting the electronic book put up in the secondary distribution market, the electronic book selling system 3 displays a list where the putting up price and the number of times of putting up (or the remaining number of times putting up is allowed) can be grasped for each electronic book, for example. In consideration of selling later, in the secondary distribution market, the electronic book purchased here, the user considers purchase in consideration of not only the putting up price but also the number of electronic books of the same title being put up and the number of times of putting up of each electronic book (the remaining number of times putting up is allowed), and therefore these pieces of information are provided as the reference information. Since the electronic book is digital data and there is no physical difference for each putting up, there is no need to present information on those who put up.

The user decides and instructs an electronic book to purchase from among the electronic books being put up. In the digital content secondary distribution system 1, the purchase processing unit 15 receives information on the target electronic book to purchase designated via the electronic book selling system 3, and registers the fact of purchase with respect to the putting up information related to the target electronic book recorded in the putting up DB 141 (S32). In a case where a plurality of electronic books having the same title and the same number of times of putting up (remaining number of times putting up is allowed) are put up, when the user intends to purchase the electronic book, for example, control may be performed such that one having the lowest putting up price is automatically selected. In a case where a plurality of products with the lowest putting up price are put up, control may be performed such that the one put up earliest is automatically selected.

Thereafter, the electronic book selling system 3 performs payment processing for the user who has purchased the electronic book, and performs processing of granting a point usable in the electronic bookstore to the one who has put up the target electronic book as a compensation for the selling of the electronic book (S33). Then, processing of transferring the access to book related to the target electronic book from the one who put up to the purchaser is performed (S34), and the purchase processing ends. The series of processing from steps S32 to S34 is transaction processing performed indivisibly and exclusively.

Although not illustrated, the user can check the purchase status and the like of the electronic book put up in the secondary distribution market by the user himself/herself via the electronic book selling system 3 at a discretionary timing. In the digital content secondary distribution system 1, the putting up management unit 14 acquires, from the putting up DB 141, information on the electronic book put up by the user and information on whether or not the electronic book is purchased, and presents, via the electronic book selling system 3, the information to the one who put up. At this time, information on the point granted to the user is also presented.

In the present embodiment, the compensation, to the one who put up, for the purchase of the electronic book being put up is a point that can be used in the target electronic bookstore, as described above, regardless of whether the purchaser paid in cash or paid in point. Then, availability of this point is limited to purchase of a new electronic book primarily distributed in the electronic bookstore, and its expiration date is also limited to a certain period (for example, six months). This facilitates further activation of primary distribution and secondary distribution in the target electronic bookstore.

### Screen Example

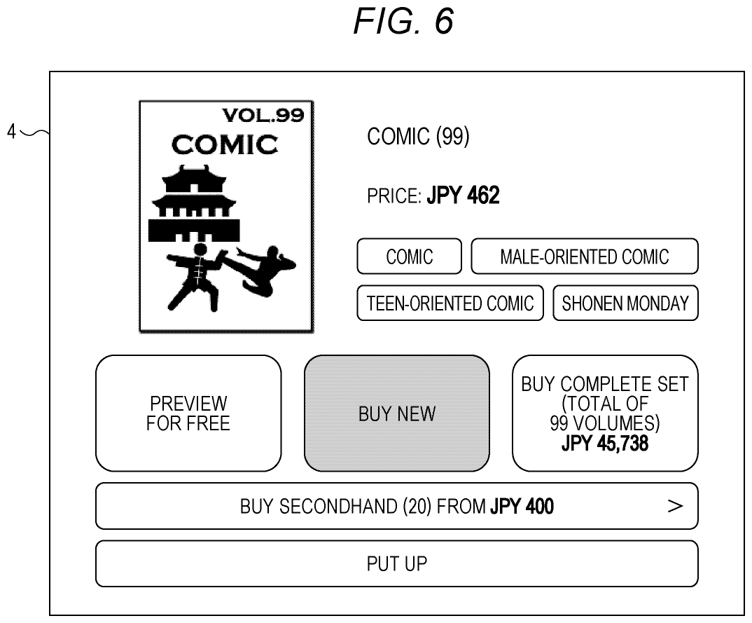

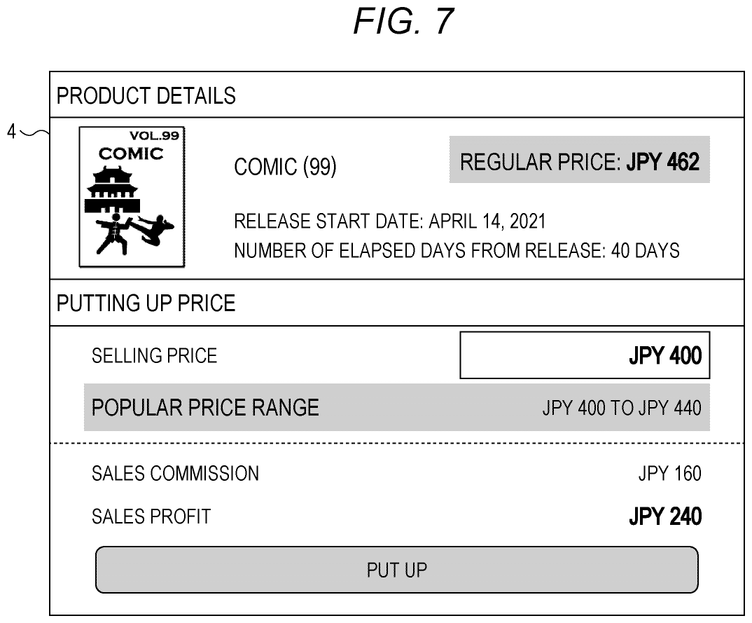

FIGS. 6 and 7 are views illustrating an outline of an example of the screen displayed on the user terminal 4 by the electronic book selling system 3 in one embodiment of the present invention. FIG. 6 illustrates an example of the screen when the user accesses the electronic book selling system 3 using the user terminal 4 and searches for an electronic book handled in the electronic bookstore according to the electronic book selling system 3. Here, the electronic book titled “COMIC” is displayed as the search result, indicating that the selling price of the new book is 462 Japanese Yen (JPY).

In a case where the publisher has licensed secondary distribution of the electronic book and a secondhand product of the electronic book has already been put up by another user, a “buy secondhand” button is displayed at the lower part of the screen as illustrated in the drawing, and the user can purchase the secondhand product of the electronic book by clicking, tapping, or the like (hereinafter, simply referred to as “clicking” in some cases) on this button. The example of FIG. 6 indicates that 20 secondhand products of the electronic book are put up, and the lowest putting up price among them is 400 JPY.

In a case where the publisher has licensed secondary distribution of the electronic book and the user has already purchased and owned a new or secondhand product of the electronic book, a “put up” button is displayed at the lower part of the screen as illustrated, and the user can put up the electronic book owned by the user himself/herself in the secondary distribution market by clicking the “sell” button.

FIG. 7 illustrates an example of the screen when the user puts up the electronic book owned by the user himself/herself to the secondary distribution market. This screen is displayed when the user clicks on the “put up” button in the above-described screen example of FIG. 6, for example. This screen may be displayed when the user displays a list of his/her purchase history in the electronic bookstore, designates the target electronic book from the list, and issue an instruction to put up the target electronic book.

The “item detail” field in the upper part of FIG. 7 indicates that the new product price of the electronic book titled “COMIC” owned by the user is 462 JPY. In a case where the item owned by the user is a secondhand item, the price at the time of purchase of the secondhand item may be displayed together with it. The release start date of the electronic book and the number of elapsed days from the release are also displayed, and can be used as reference information when the user sets the putting up price.

In the “putting up price” field in the lower part of FIG. 7, the user can set the selling price when putting up the target electronic book in the secondary distribution market. At this time, the system may recommend a “popular” price range as an analysis result based on, for example, transaction data accumulated in the past or information such as the number of elapsed days from release. With respect to the selling price set by the user, the amount of the sales commission taken by the electronic bookstore side calculated based on a predetermined condition and the amount of the sales profit taken by the user calculated by subtracting the amount of the sales commission from the selling price are also displayed. When the user clicks the “put up” button at the lower part of the screen, the target electronic book is put up in the secondary distribution market at the selling price having been set.

By returning a part of the sales commission to the publisher as a license fee, for example, the sales commission taken by the electronic bookstore side can support creation of digital content to be newly sold in the primary distribution market and lead to activation of the primary distribution market. It is also possible to activate the primary distribution market by returning the sales profit taken by the user who put up, as described above, as a usable point limited only to purchase of a new electronic book in the electronic bookstore.

As described above, according to the digital content secondary distribution system 1 that is one embodiment of the present invention, it becomes possible for an electronic bookstore to easily achieve the secondary distribution market of digital content, and it is possible to provide the user with an opportunity to easily purchase digital content at a low price, activate the secondary distribution market of the digital content, and lead to activation of the primary distribution market. As described above, the publisher management systems 2 of the plurality of publishers and the electronic book selling systems 3 of the plurality of electronic bookstores can access the digital content secondary distribution system 1 via the network 5 and use various functions related to secondary distribution of the electronic book. The digital content secondary distribution system 1 provides various functions as an API, and each publisher management system 2 and each electronic book selling system 3 use various functions related to secondary distribution of electronic books by calling these APIs ad hoc. Therefore, secondary distribution of digital content can be achieved by minimum modification of each existing publisher management system and each existing electronic book selling system. Unlike actual used books, there is no quality superiority or inferiority (degree of damage) in secondary distribution of digital content. Thus, the main criterion for the end user to select a plurality of secondhand products of the same content will be the price. Therefore, in the case of the same price, the system side may preferentially present, to the end user, or set, as a payment target, an item put up earlier in terms of period, and it becomes possible to not only save the time and effort of selection by the end user but also reduce a system load associated with the selection.

The invention carried out by the present inventor has been specifically described based on the embodiment. However, it is needless to say that the present invention is not limited to the above-described embodiment but can be modified in various manners in a scope without departing from the gist of the present invention. The above embodiment has been described in detail in order to explain the present invention in an easy-to-understand manner, and the present invention is not necessarily limited to one including all the configurations described. Another configuration can be added to, deleted from, and replaced with a part of the configuration of the above-described embodiment.

For example, in the above embodiment, the configuration in which the owner of digital content puts up the digital content and obtains the point has been described, but in addition to this configuration, a configuration in which each electronic bookstore directly purchases back from the owner of the digital content by the electronic book selling system may be added. In this case, even in a case where the price at the time of purchasing back is set sufficiently low, there is no step of purchase by a general user in the case of purchasing back as compared with the case of putting up and selling, and thus, there is no corresponding lead time, which is beneficial for the owner who wants to sell immediately. For example, in a case where a certain owner wants to buy an electronic book but owns insufficient points, the amount becomes lower than that in a case of putting up, but when the electronic bookstore purchases it back, it becomes possible to quickly sell it and immediately obtain the electronic book that the owner wants.

A part or all of the above-described configurations, functions, processing units, processing means, and the like may be implemented by hardware by being designed as an integrated circuit or the like. Alternatively, the above configurations, functions, and the like may be implemented by software by a processor interpreting and executing a program that implements each function. Information such as programs, tables, and files for implementing each function can be stored in a recording device such as a memory, a hard disk, and a solid state drive (SSD), or in a recording medium such as an IC card, an SD card, and a DVD.

The above drawings illustrate control lines and information lines that are considered necessary for the description, and do not necessarily illustrate all the implemented control lines and information lines. In reality, almost all the configurations may be considered mutually connected.

The present invention is applicable to a digital content secondary distribution system that supports and manages secondary distribution of digital content.

What is claimed is:

1. A digital content secondary distribution system that supports secondary distribution, by a user, of digital content purchased and possessed by the user, the digital content secondary distribution system comprising:
a secondary distribution license processing unit that receives and records, into a secondary distribution book recording unit, designation, by an issuer of the digital content, of first digital content for which secondary distribution is licensed among digital content issued by the issuer;
a putting up management unit that receives and records, into a putting up recording unit, an instruction, by a first user who purchases and possesses the first digital content from a seller, of putting up via the seller, of second digital content of the first digital content that is possessed; and
a purchase processing unit that receives an instruction, by a second user, of purchase of the second digital content put up by the first user, and updates information on the putting up recording unit,
wherein the putting up management unit limits a number of times the second digital content that is identical can be put up to equal to or less than a predetermined number of times.

2. The digital content secondary distribution system according to claim 1,
wherein the putting up management unit limits a selling price that can be set when the first user puts up the second digital content not to be less than an amount in which an amount of a predetermined rate set in accordance with a number of times of putting up of the second digital content is discounted with respect to a price when the first user purchased the second digital content.

3. The digital content secondary distribution system according to claim 1,
wherein at a time point when the first user read the second digital content, the first user puts up the second digital content via the seller with an amount in which a predetermined rate is discounted from a price when the first user purchased the second digital content being set as a selling price.

4. The digital content secondary distribution system according to claim 1,
wherein the secondary distribution license processing unit limits a starting period in which the issuer can license secondary distribution of the first digital content after a lapse of a predetermined period from when the first digital content is issued.

5. The digital content secondary distribution system according to claim 1,
wherein the second user is granted a point usable for a predetermined period for purchase of digital content from the seller.

6. The digital content secondary distribution system according to claim 1,
wherein the secondary distribution license processing unit receives and records, in a secondary distribution bookstore recording unit, designation of a seller who handles secondary distribution of the first digital content by the issuer.
